(19) United States
(12) Patent Application Publication
(10) Pub. No.: US 2022/0375096 A1
(43) Pub. Date: Nov. 24, 2022

(54) SYSTEM AND METHOD TO DETECT QUALITY OF SILK COCOONS

(71) Applicant: SHAPOS SERVICE PVT LTD, Bangaluru (IN)

(72) Inventors: Saurabh Kumar Agarwal, Bengaluru (IN); Mayank Tiwari, Bengaluru (IN); Utkarsh Apoorva, Bengaluru (IN); Priyanka Chakraborty, Bengaluru (IN)

(21) Appl. No.: 17/672,743

(22) Filed: Feb. 16, 2022

(30) Foreign Application Priority Data
May 10, 2021 (IN) 202141021048

(51) Int. Cl. G06T 7/13; G06T 7/62; G06T 7/194; G06T 5/00

(52) U.S. Cl. CPC G06T 7/13; G06T 7/62; G06T 7/194; G06T 5/002

(57) ABSTRACT

A system to detect quality of a silk cocoon is disclosed. The plurality of subsystems includes an image processing subsystem, configured to process the captured image of the one or more silk cocoons for noise. The plurality of subsystems includes an object detection subsystem, configured to detect cocoon contours from processed image. The plurality of subsystems also includes a cocoon analysing subsystem, configured to identify shape of the cocoon from the detected cocoon contours by using a shape function, compute a set of the parameters, validate the set of parameters with prestored parameters and determine the quality of each of the one or more silk cocoons based on the results of validation. The system uses OpenCV functions of python to do such complex work of grading silk cocoons. Such process reduces manual labour all together.

### EARLIEST PRIORITY DATE

This Application claims priority from a Provisional patent application filed in India having Patent Application No. 202141021048, filed on May 10, 2021 and titled “METHOD AND APPARATUS FOR CLASSIFICATION OF SILK COCOON TYPES BASED ON COMPUTER VISION”

### FIELD OF INVENTION

Embodiments of the present disclosure relates to image processing systems, and more particularly to a system and a method to detect quality of silk cocoons.

### BACKGROUND

Conventionally, market price of silk cocoons is assessed on the basis of silk cocoon quality. Quality of each silk cocoon depends on factors such as shape, size, colour, solidity, and the like. For example, uneven thickness of the silk cocoon has large effect for raw material silk quality.

Currently, the quality of the silk cocoons is assessed manually and is highly prone to human error. Each silk cocoon is selected for further processing by manually judging the shape, the size and the colour. Effective judging mechanism is needed to rectify the errors made during the manual selection process.

Such manual assessment has poor repeatability and constitutes a significant cost factor in the garment manufacturing process. The quality determination is a vital process as quality factor automatically affects the garment production output.

Hence, there is a need for an improved and automated system to detect quality of silk cocoons and a method to operate the same and therefore address the aforementioned issues.

### BRIEF DESCRIPTION

In accordance with one embodiment of the disclosure, a system to detect quality of a silk cocoon is disclosed. The system includes a hardware processor. The system also includes a memory coupled to the hardware processor. The memory comprises a set of program instructions in the form of a plurality of subsystems.

The plurality of subsystems includes an image capturing subsystem. The image capturing subsystem is configured to capture an image of one or more silk cocoons from one or more image capturing devices. The plurality of subsystems also includes an image processing subsystem. The image processing subsystem is configured to process the captured image of the one or more silk cocoons for noise reduction.

The plurality of subsystems also includes an object detection subsystem. The object detection subsystem is configured to detect cocoon contours from the processed image of the one or more silk cocoons. The plurality of subsystems also includes a cocoon analysing subsystem. The cocoon analysing subsystem is configured to identify shape of the cocoon based the detected cocoon contours by using a shape function.

The cocoon analysing subsystem is also configured to compute a first set of the parameters associated with the cocoon based on the identified shape of the cocoon. The cocoon analysing subsystem is also compute a second set of parameters associated with the cocoon based on the computed first set of parameters. The cocoon analysing subsystem is also configured to validate first set of parameters and the second set of parameters associated with the cocoon based on prestored parameters. The cocoon analysing subsystem is also configured to determine the quality of each of the one or more silk cocoons based on the results of validation. The cocoon analysing subsystem is also configured to output the determined quality of each of the one or more on a user interface of a user device.

In accordance with one embodiment of the disclosure, a method for detecting quality of a silk cocoon is disclosed. The method includes capturing an image of one or more silk cocoons from one or more image capturing devices. The method also includes processing the captured image of the one or more silk cocoons for noise reduction. The method also includes detecting cocoon contours from the processed image of the one or more silk cocoons.

The method also includes identifying shape of the cocoon based on the detected cocoon contours by using a shape function. The method also includes computing a first set of the parameters associated with the cocoon based on the identified shape of the cocoon. The method also includes computing a second set of parameters associated with the cocoon based on the computed first set of parameters. The method also includes validating first set of parameters and the second set of parameters associated with the cocoon based on prestored parameters. The method also includes determining the quality of each of the one or more silk cocoons based on the results of validation. The method also includes outputting the determined quality of each of the one or more cocoons on a user interface of a user device.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram illustrating an exemplary computing system to detect quality of a silk cocoon in accordance with an embodiment of the present disclosure;

FIG. 2A-D illustrates a schematic representation of processed images of the one or more silk cocoons, in accordance with an embodiment of the present disclosure;

FIG. 3A-D illustrates a schematic representation of object detection mechanism performed on the processed images of the one or more silk cocoons, in accordance with an embodiment of the present disclosure;

FIG. 4 illustrates a schematic representation of feature engineering mechanism performed on the processed images of the one or more silk cocoons, in accordance with an embodiment of the present disclosure; and

FIG. 5 is a process flowchart illustrating an exemplary method for detecting quality of a silk cocoon in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated online platform, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, subsystems, elements, structures, components, additional devices, additional subsystems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

A computer system (standalone, client or server computer system) configured by an application may constitute a “subsystem” that is configured and operated to perform certain operations. In one embodiment, the “subsystem” may be implemented mechanically or electronically, so a subsystem may comprise dedicated circuitry or logic that is permanently configured (within a special-purpose processor) to perform certain operations. In another embodiment, a “subsystem” may also comprise programmable logic or circuitry (as encompassed within a general-purpose processor or other programmable processor) that is temporarily configured by software to perform certain operations.

Accordingly, the term “subsystem” should be understood to encompass a tangible entity, be that an entity that is physically constructed permanently configured (hardwired) or temporarily configured (programmed) to operate in a certain manner and/or to perform certain operations described herein.

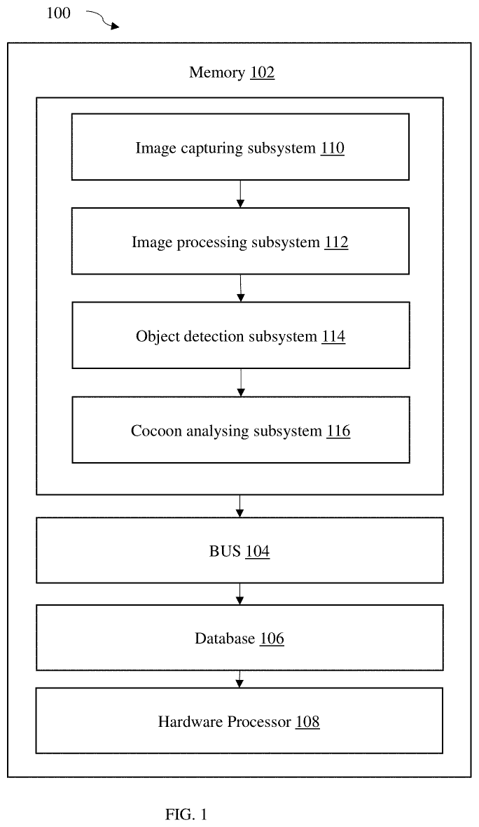

FIG. 1 is a block diagram illustrating an exemplary computing system 100 to detect quality of a silk cocoon in accordance with an embodiment of the present disclosure. The computing system 100 inspects the silk cocoon quality from the silk cocoon colour, the silk cocoon size, the silk cocoon shape and the silk cocoon solidity. The computing system 100 automatically access the silk cocoon quality through captured images of one or more cocoons and application of computer vision techniques. The computing system 100 segregates good or bad quality silk cocoons.

As used herein, the term “cocoon” refers to a covering of thin threads that some insects make to protect themselves before becoming adults.

The computing system 100 includes a hardware processor 108. The computing system 100 also includes a memory 102 coupled to the hardware processor 108. The memory 102 comprises a set of program instructions in the form of a plurality of subsystems.

The hardware processor(s) 108, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 102 includes a plurality of subsystems stored in the form of executable program which instructs the hardware processor 108 via bus 104. The plurality of subsystems has following subsystems: an image capturing subsystem 110, an image processing subsystem 112, an object detection subsystem 114 and a cocoon analysing subsystem 116.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the hardware processor(s) 108.

The plurality of subsystems includes an image capturing subsystem 110. The image capturing subsystem 110 is configured to capture an image of one or more silk cocoons from one or more image capturing devices. In one embodiment, the one or more image capturing devices may be any handheld camera device, a mobile device and the like. In another embodiment, the image capturing subsystem 110 receives scanned image from the one or more image capturing devices of the one or more silk cocoons for processing.

In such embodiment, the captured image is in standard BGR scale. RGB stands for Red Green Blue. An RGB colour is stored in a structure or unsigned integer with Blue occupying the least significant “area” (a byte in 32-bit and 24-bit formats), Green the second least, and Red the third least.

The plurality of subsystems also includes an image processing subsystem 112. The image processing subsystem 112 is configured to process the captured image of the one or more silk cocoons for noise reduction. In such embodiment, image processing subsystem 112 processes the captured image by using OpenCV package from python. OpenCV is an open-source library for computer vision, machine learning, and image processing, whereby OpenCV can process images and videos to identify objects, faces, or even the handwriting of a human.

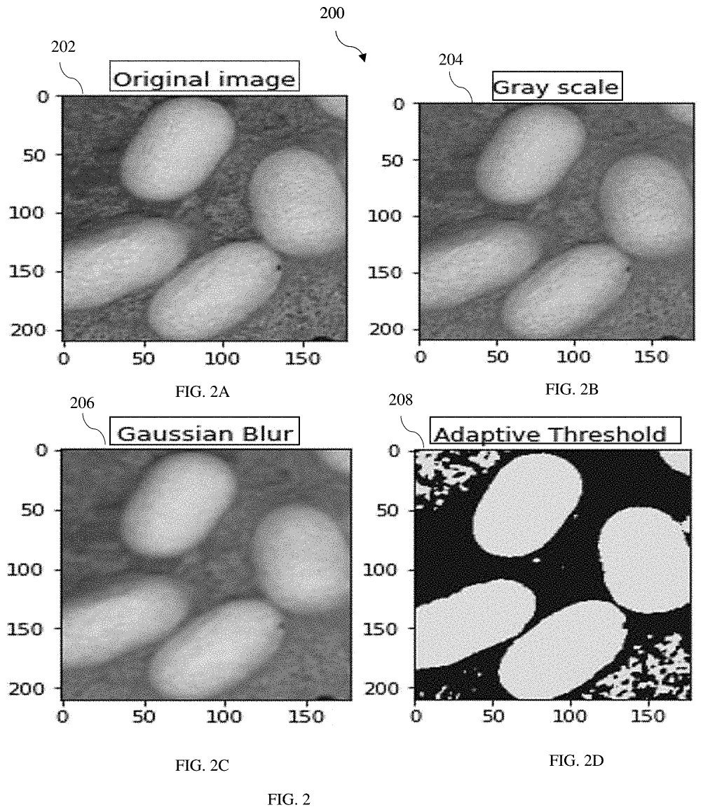

FIG. 2A-D illustrates a schematic representation of processed images 200 of the one or more silk cocoons, in accordance with an embodiment of the present disclosure. In one embodiment, the standard Blue Green Red (BGR) scale of the captured image 202 is converted to grayscale image 204. In such embodiment, the grayscale image 204 is used to implement a Gaussian Blur operation to remove high frequency components of the captured image. The Gaussian Blur operation is achieved by allowing implementation of a low pass filter.

In such embodiment, adaptive thresholding is performed on blurred image 206 for image segmentation 208. The image segmentation 208 helps in segmenting foreground from background of the captured image. The processing is done by function from OpenCV package. The function may be depicted as:

img=cv2.imread(‘new_image.jpeg’)

gray=cv2.cvtColor(img,cv2.COLOR_BGR2GRAY)

threshBlur=cv2.bilateralFilter(gray,5,75,75)

thresh=cv2.adaptiveThreshold(thresh_blur, 255,
cv2.ADAPTIVE_THRESH_MEAN_C, cv2.THRESH_BINARY, 199, 7)

The plurality of subsystems also includes an object detection subsystem 114. The object detection subsystem 114 is configured to detect cocoon contours from the processed image of the one or more silk cocoons. The object detection subsystem 114 detects cocoon contours by using the OpenCV package from python.

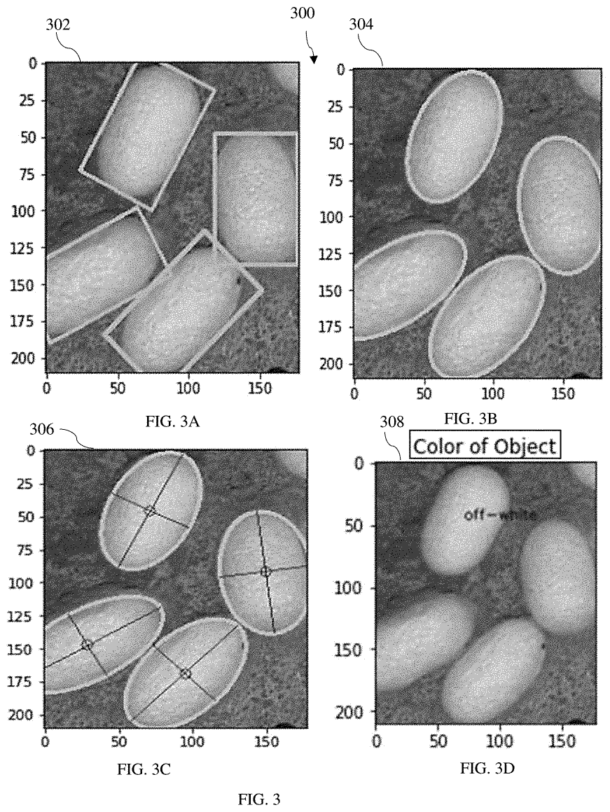

FIG. 3A-D illustrates a schematic representation of object detection mechanism 300 performed on the processed images of the one or more silk cocoons, in accordance with an embodiment of the present disclosure.

After processing the captured image for removal of noise, the captured image is further pre-processed for the identification of multiple objects 302. The object detection is achieved by contour detection 302 function in OpenCV. In OpenCV, contours refer to finding white objects from black background. As used herein, the term “contour” is a curve joining all the continuous points (along the boundary), having the same colour or intensity. The contour detection function in OpenCV may be depicted as:

contours,hierarchy=cv2.findContours(thresh,

cv2.RETR_LIST,

cv2.CHAIN_APPROX_SIMPLE)

area_all=[cv2.contourArea(c) for c in contours]

The plurality of subsystems also includes a cocoon analysing subsystem 116. The cocoon analysing subsystem 116 is configured to identify shape of the silk cocoon based on the detected cocoon contours by a using shape function. The computing system 100 assumes each of the one or more silk cocoon shape is perfect ellipsoid. In such embodiment, to identify shape of the silk cocoon, the cocoon analysing subsystem 116 fits ellipse boundary 304 over detected silk contour 302. The shape function of OpenCV may be depicted as:

ellipse=cv2.fitEllipse(contours)

The cocoon analysing subsystem 116 is also configured to compute a first set of the parameters 306 and 308 associated with the cocoon based on the identified shape of the cocoon. In one embodiment, the first set of parameters comprises major axis value 306, minor axis value 306 and colour 308 of the detected cocoon contour.

In one such embodiment, the major axis value 306 and the minor axis value 306 are computed by using fitEllipse function of OpenCV package from python. The fitEllipse function of OpenCV package may be depicted as:

(xc, yc), (Ma, ma), angle=cv2.fitEllipse(contours)

In such function, xc and yc are coordinates of the centre of elliptical objects. The Ma and ma are major axis and minor axis respectively. The angle is the orientation of objects in the image.

In another such embodiment, the colour 308 of the detected cocoon contour is computed by using a Euclidean distance formula on one or more colours obtained from the detected cocoon contour region. The one or more colours is detected by using OpenCV package from python. The Euclidean distance formula may be depicted as:

dist (p, q)=√( [symbol] x1−x2) [symbol] \hat{ }2+(y1−y2) [symbol] \hat{ }(2) [symbol] +(z1−z2) [symbol] \hat{ }2 [symbol] Equation (1)

According to equation (1), p and q have three points x, y, and z of two different RGB values.

The cocoon analysing subsystem 116 is also configured to compute a second set of parameters associated with the cocoon based on the computed first set of parameters. In one embodiment, the second set of parameters associated with the cocoon comprises volume of each of the one or more silk cocoons, aspect ratio, and circularity from the computed major axis value and the computed minor axis value. The volume of the silk cocoon was calculated using the equation (2).

v=4/3 πa b c Equation (2)

According to equation (2), a=major axis and b, c=minor axis. The major axis of an ellipse contains the longer of the two-line segments about which the ellipse is symmetrical. The minor axis of an ellipse is the line that contains the shorter of the two-line segments about which the ellipse is symmetrical. The uniformity in size was measured based on the standard deviation in ‘v’ of each of the one or more silk cocoons presents in the image. The standard deviation was calculated as equation (3).

σ=√( [symbol] x_(i)−μ) [symbol] \hat{ }2 [symbol] [symbol] _)/N Equation (3)

According to equation 3, ‘xi’ is the volume of cocoon in the image, ‘μ’ is average volume and ‘N’ is the number of cocoons.

Furthermore, uniformity in the colour of the detected object was defined using the Gray scale image. The local binary patterns of a particular object coordinate were calculated and then the distributions were compared. The objects with non-uniform distributions were labelled as “damaged”. Additionally, in such embodiment, certain shape parameters such as aspect ratio and circularity were computed for each of the elliptical objects to quantify the extent of distortion in the shape. The shape parameters were helpful in detection of double cocoons.

The aspect ratio is measured using the major and minor axis of ellipses. Equation (4) depicts the aspect ratio formula.

(Major axis)/(Minor axis) Equation (4)

The circularity is measured using the perimeter and area of the ellipse fit on to the detected contour. Equation (5) depicts the circularity formula.

(4π(area))/ [symbol] perimeter [symbol] \hat{ }(2) Equation (5)

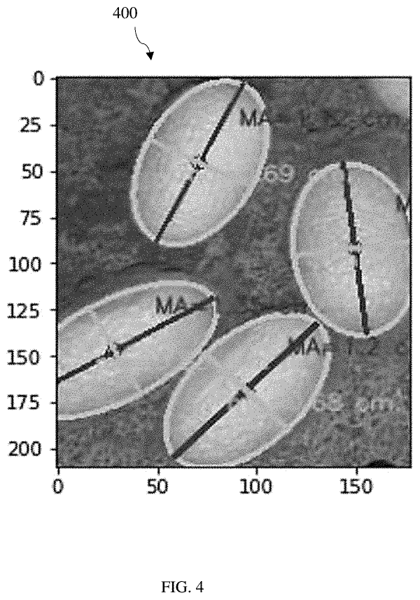

The cocoon analysing subsystem 116 is also configured to validate first set of parameters and the second set of parameters associated with the cocoon based on prestored parameters. FIG. 4 illustrates a schematic representation of feature engineering mechanism 400 performed on the processed images of the one or more silk cocoons, in accordance with an embodiment of the present disclosure.

In one embodiment, for validating the first set of parameters and the second set of parameters associated with the cocoon based on prestored parameters, the cocoon analysing subsystem 116 is configured to compare the first set of the parameters with a prestored major axis value, a prestored minor axis value and a prestored identified colour. Furthermore, cocoon analysing subsystem 116 is also compare the second set of the parameters with a prestored volume of the cocoon, a prestored aspect ratio and a prestored circularity. The database 106 is configured to store the prestored major axis value, the prestored minor axis value, the prestored identified colour, the prestored volume of the cocoon, the prestored aspect ratio and the prestored circularity.

The cocoon analysing subsystem 116 is also configured to determine the quality of each of the one or more silk cocoons based on the results of validation. In one embodiment, a quality deviation is identified based on the compared result. According to the identified quality deviation, a quality score is assigned to each of the one or more silk cocoons. In such embodiment, a cocoon is segregated based on assigned quality score.

In one specific embodiment, the cocoon analysing subsystem 116 determines a large deviation in the compared result, a simultaneous quality score is assigned. For example, the cocoon analysing subsystem 116 determines a large deviation in the major axis value and the minor axis value for specific silk cocoon. The cocoon analysing subsystem 116 assigns a score for such silk cocoon and segregates each of the one or more cocoons accordingly.

The assigned score may be in the range of 1 to 10. In such embodiment, if the score value reaches closer to 10, the detected silk cocoon quality is bad. The segregation is done in done in two grades, i.e. bad quality and good quality.

The cocoon analysing subsystem 116 is also configured to output the determined quality of each of the one or more cocoons on a user interface of a user device. In one embodiment, the determined quality result may also include best silk cocoon image. In another embodiment, the user device may include a desktop, a mobile device, a smart device and the like.

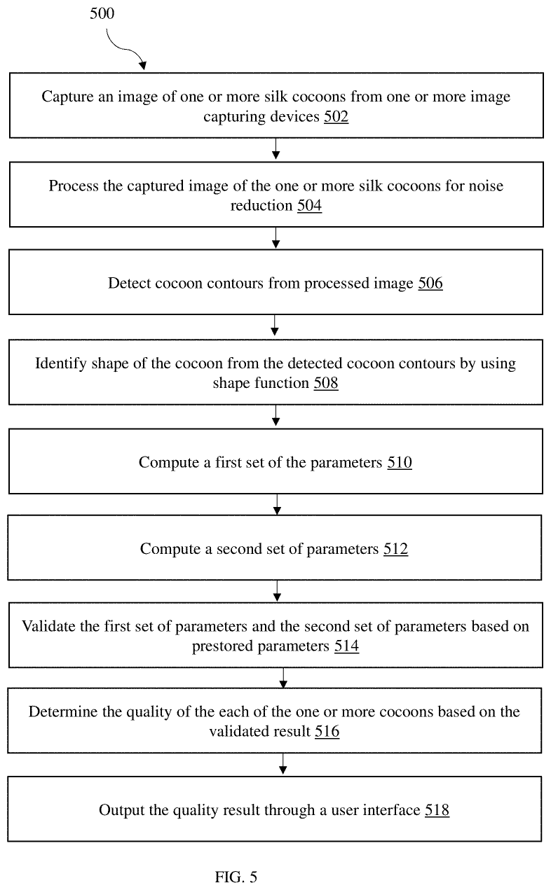

FIG. 5 is a process flowchart illustrating an exemplary method 500 for detecting quality of a silk cocoon in accordance with an embodiment of the present disclosure.

In step 502, an image of one or more silk cocoons is captured from one or more image capturing devices. In one aspect of the present embodiment, the image of the one or more silk cocoons is captured by an image capturing subsystem 110.

In step 504, the captured image of the one or more silk cocoons is processed for noise reduction. In one aspect of the present embodiment, the captured image of the one or more silk cocoons is processed by an image processing subsystem 112.

In one embodiment, the standard Blue Green Red (BGR) scale of the captured image 202 is converted to grayscale image 204. In such embodiment, the grayscale image 204 is used to implement a Gaussian Blur operation to remove high frequency components of the captured image. In such embodiment, adaptive thresholding is performed on blurred image 206 for image segmentation 208. The image segmentation 208 helps in segmenting the foreground from the background of the captured image.

In step 506, cocoon contours are detected from the processed image of the one or more silk cocoons. In one aspect of the present embodiment, cocoon contours are detected by an object detection subsystem 114.

In step 508, shape of the cocoon based on the detected silk cocoon contours is identified by using a shape function. In one aspect of the present embodiment, shape of the cocoon based on the detected silk cocoon contours is identified by a cocoon analysing subsystem 116. In such embodiment, shape of the cocoon comprises an elliptical shape.

In step 510, a first set of the parameters associated with the cocoon based on the identified shape of the cocoon is computed. In one aspect of the present embodiment, the first set of parameters associated with the cocoon based on the identified shape of the cocoon is computed by the cocoon analysing subsystem 116. In one embodiment, the first set of parameters associated with the cocoon based on the identified shape of the cocoon comprises major axis value, minor axis value and colour of the detected cocoon contour.

The major axis value and the minor axis value are computed by using fitEllipse function of OpenCV package from python. The colour of the detected cocoon contour is computed by using a Euclidean distance on one or more colours obtained from the detected cocoon contour region.

In step 512, a second set of parameters associated with the cocoon based on the computed first set of parameters is computed. In one aspect of the present embodiment, the second set of parameters associated with the cocoon based on the computed first set of parameters is computed by the cocoon analysing subsystem 116. In such embodiment, the second set of parameters associated with the cocoon based on the computed first set of parameters comprises volume of each of the one or more silk cocoons, aspect ratio, and circularity from the computed major axis value and the computed minor axis value.

In such embodiment, the volume of each of the one or more silk cocoons is computed from the computed major axis value and the computed minor axis value. The method also includes computing volume uniformity of each of the one or more silk cocoons by applying standard deviation, the aspect ratio and the circularity.

In step 514, the first set of parameters and the second set of parameters associated with the cocoon is validated based on prestored parameters. In one aspect of the present embodiment, the first set of parameters and the second set of parameters associated with the cocoon is validated by the cocoon analysing subsystem 116. The validation includes comparing the first set of the parameters with a prestored major axis value, a prestored minor axis value and a prestored identified colour. The validation also includes comparing the second set of the parameters with a prestored volume of the cocoon, a prestored aspect ratio and a prestored circularity.

In step 516, the quality of each of the one or more silk cocoons is determined based on the results of validation. In one aspect of the present embodiment, the quality of each of the one or more silk cocoons is determined by the cocoon analysing subsystem 116. In one embodiment, a quality deviation is identified based on the compared result. According to the identified quality deviation, a quality score is assigned to each of the one or more silk cocoons. In such embodiment, a cocoon is segregated each of the one or more cocoons based on the assigned quality score.

In step 518, the determined quality of each of the one or more cocoons is outputted on a user interface of a user device. In one aspect of the present embodiment, the determined quality of each of the one or more cocoons is outputted by the cocoon analysing subsystem 116.

Present disclosure provides an automatic approach to detect quality of a silk cocoon. The computing system 100 uses OpenCV function of python to analyse a cocoon in real time and provide a good quality or bad quality grade for each silk cocoon. Such process completely removes the manual detection process and hence the associated errors are also removed.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependant on other acts may be performed in parallel with the other acts. The scope of embodiments is by no means limited by these specific examples.

We claim:

1. A system to detect quality of a silk cocoon, the system comprising:
a hardware processor; and
a memory coupled to the hardware processor, wherein the memory comprises a set of program instructions in the form of a plurality of subsystems, configured to be executed by the hardware processor, wherein the plurality of subsystems comprises:
an image capturing subsystem configured to capture an image of one or more silk cocoons from one or more image capturing devices;
an image processing subsystem configured to process the captured image of the one or more silk cocoons for noise reduction;
an object detection subsystem configured to detect cocoon contours from the processed image of the one or more silk cocoons;
a cocoon analysing subsystem configured to:
identify shape of the cocoon based on the detected silk cocoon contours by using a shape function, wherein the shape of the cocoon comprises an elliptical shape;
compute a first set of the parameters associated with the cocoon based on the identified shape of the cocoon, wherein the first set of parameters comprises major axis value, minor axis value and colour of the detected cocoon contour;
compute a second set of parameters associated with the cocoon based on the computed first set of parameters, wherein the second set of parameters comprises information representative of volume of each of the one or more silk cocoons, aspect ratio, and circularity from the computed major axis value and the computed minor axis value;
validate the first set of parameters and the second set of parameters associated with the cocoon based on prestored parameters;
determine quality of the each of the one or more cocoons based on the results of validation; and
output the determined quality of each of the one or more cocoons on a user interface of a user device.

2. The system as claimed in claim 1, wherein in processing the captured image, the image processing subsystem is configured to:
convert the standard Blue Green Red (BGR) scale of the captured image to grayscale image;
perform a Gaussian Blur operation on the grayscale image to remove high frequency components of the captured image; and
perform adaptive thresholding on blurred image for image segmentation to segment foreground from background of the captured image.

3. The system as claimed in claim 1, wherein in computing the second set of parameters associated with the cocoon, the cocoon analysing subsystem is configured to:
compute the volume of each of the one or more silk cocoons from the computed major axis value and the computed minor axis value; and
compute volume uniformity of each of the one or more silk cocoons by applying standard deviation, the aspect ratio and the circularity.

4. The system as claimed in claim 1, wherein in validating the first set of parameters and the second set of parameters associated with the cocoon based on prestored parameters, the cocoon analysing subsystem is configured to:
compare the first set of the parameters with a prestored major axis value, a prestored minor axis value and a prestored identified colour; and
compare the second set of the parameters with a prestored volume of the cocoon, a prestored aspect ratio and a prestored circularity.

5. The system as claimed in claim 1, wherein in determining the quality of each of the one or more silk cocoons based on the results of validation, the cocoon analysing subsystem is configured to:
identify a quality deviation for each of the one or more silk cocoons based on the compared result;
assign a quality score to each of the one or more silk cocoons based on the identified quality deviation; and
segregate each of the one or more cocoons based on the assigned quality score.

6. The system as claimed in claim 1, wherein the major axis value and the minor axis value are computed by using fitEllipse function

7. The system as claimed in claim 1, wherein the colour of the detected cocoon contour is computed by using a Euclidean distance on one or more colours obtained from the detected cocoon contour region.

8. A method for detecting quality of a silk cocoon, the method comprising:
capturing, by a processor, an image of one or more silk cocoons from one or more image capturing devices;
processing, by a processor, the captured image of the one or more silk cocoons for noise reduction;
detecting, by the processor, cocoon contours from the processed image of the one or more silk cocoons;
identifying, by the processor, shape of the cocoon based on the detected cocoon contours by using a shape function, wherein the shape of the cocoon comprises an elliptical shape;
computing, by the processor, a first set of the parameters associated with the cocoon based on the identified shape of the cocoon, wherein the first set of parameters comprises major axis value, minor axis value and colour of the detected cocoon contour;
computing, by the processor, a second set of parameters associated with the cocoon based on the computed first set of parameters, wherein the second set of parameters information representative of volume of each of the one or more silk cocoons, aspect ratio, and circularity from the computed major axis value and the computed minor axis value;
validating, by the processor, the first set of parameters and the second set of parameters associated with the cocoon based on prestored parameters;
determining, by the processor, the quality of the each of the one or more cocoons based on the results of validation; and
outputting, by the processor, the determined quality of each of the one or more cocoons on a user interface of a user device.

9. The method as claimed in claimed 8, wherein the processing of the captured image comprises:
converting the standard Blue Green Red (BGR) scale of the captured image to grayscale image;
performing a Gaussian Blur operation on the grayscale image to remove high frequency components of the captured image; and
performing adaptive thresholding on blurred image for image segmentation to segment foreground from background of the captured image.

10. The method as claimed in claim 8, wherein computing the second set of parameters associated with the cocoon comprises:
computing the volume of each of the one or more silk cocoons from the computed major axis value and the computed minor axis value; and
computing volume uniformity of each of the one or more silk cocoons by applying standard deviation, the aspect ratio and the circularity.

11. The method as claimed in claim 8, wherein for validating of the first set of parameters and the second set of parameters associated with the cocoon based on prestored parameters comprises:
comparing the first set of the parameters with a prestored major axis value, a prestored minor axis value and a prestored identified colour; and
comparing the second set of the parameters with a prestored volume of the cocoon, a prestored aspect ratio and a prestored circularity.

12. The method as claimed in claim 8, wherein for determining the quality of each of the one or more silk cocoons based on the results of validation comprises:
identifying a quality deviation for each of the one or more silk cocoons based on the compared result;
assigning a quality score to each of the one or more silk cocoons based on the identified quality deviation; and
segregating each of the one or more cocoons based on the assigned quality score.

13. The method as claimed in claim 8, wherein the major axis value and the minor axis value are computed by using fitEllipse function.

14. The method as claimed in claim 8, wherein the colour of the detected cocoon contour is computed by using a Euclidean distance on one or more colours obtained from the detected cocoon contour region.
